(19) United States
(12) Patent Application Publication
(10) Pub. No.: US 2020/0306134 A1
(43) Pub. Date: Oct. 1, 2020

(54) MECHANICAL CARDIOPULMONARY RESUSCITATION DEVICE

(71) Applicant: Sunnybrook Research Institute, Toronto (CA)

(72) Inventors: Miles MONTGOMERY, North York (CA); Reniel ENGELBRECHT, St. John's (CA); Brian COURTNEY, Toronto (CA); Michelle JENNETT, Richmond Hill (CA)

(21) Appl. No.: 16/830,402

(22) Filed: Mar. 26, 2020

Related U.S. Application Data
(60) Provisional application No. 62/824,045, filed on Mar. 26, 2019.

(51) Int. Cl. A61H 31/00

(52) U.S. Cl. CPC A61H 31/006; A61H 2230/205; A61H 2230/305; A61H 31/005

(57) ABSTRACT

The present disclosure provides a cardio pulmonary resuscitation (CPR) apparatus for performing a chest compression on a patient supported by a support. The apparatus includes an actuator operatively coupled to a compression mechanism for actuating the compression mechanism to perform the chest compression. The compression mechanism is securable to the support and is configured to repeatedly perform chest compressions on the patient in an operating space, the operating space being the space in which the compression mechanism operates. The actuator is positioned outside of the operating space. The present disclosure further provides a monitoring system having the CPR apparatus and a feedback system coupled to the CPR apparatus.

### CROSS-REFERENCE TO RELATED APPLICATION

This application claims priority to U.S. Provisional Patent Application No. 62/824,045, titled “MECHANICAL CARDIOPULMONARY RESUSCITATION DEVICE” and filed on Mar. 26, 2019, the entire contents of which is incorporated herein by reference.

### FIELD

This disclosure generally relates to an apparatus and system for effecting cardiopulmonary resuscitation (CPR).

### BACKGROUND

CPR is a well-known and valuable method of first aid used on people who have suffered from cardiac arrest or cessation of breathing. Among other things, CPR requires repetitive chest compressions to pump the heart and the thoracic cavity to push blood through the body. Upon cardiac arrest, the patient may be at home, out in public, on the move or already in a hospital setting. In efforts to provide better blood flow and increase the effectiveness of resuscitation efforts, various mechanical devices have been used for performing CPR in these different settings.

In hospital or clinical settings, piston-driven automated CPR apparatuses are often used. Sometimes referred to as resuscitators, these apparatuses seek to produce sternal compressions to achieve well-recognized global guidelines (e.g., ILCOR, ERC, AHA, etc.). They typically include a reciprocal chest plunger that is positioned by a mounting frame above the patient's chest or that is otherwise secured to the patient's chest by a plurality of straps. A driving means causes the reciprocal chest plunger to be extended to and retracted from the patient's chest so as to compress the heart. A second type of automated CPR apparatus uses load-distribution band technology that employs thoracic compressions over a larger region of the anterior chest wall.

Many of these devices are useful for resuscitation outside a hospital setting. However, in the hospital setting, such as in a catheterization lab, or “cath lab”, the use of conventional piston-driven automated CPR apparatuses may have limitations, such as interfering with imaging that may be required, such as angiographic imaging.

As well, during an emergency situation, such as if cardiac arrest occurs during an operating procedure and time is of the essence, conventional piston-driven automated CPR apparatuses may require too much time for the piston-driven automated CPR apparatuses and/or the patient to be positioned in the proper position for use.

### SUMMARY

According to an example aspect, the present disclosure provides a cardio pulmonary resuscitation (CPR) apparatus for performing a chest compression on a patient supported by a support, the CPR apparatus comprising: an actuator operatively coupled to a compression mechanism for actuating the compression mechanism to perform the chest compression; the compression mechanism being securable to the support and configured to repeatedly perform chest compressions on the patient in an operating space, the operating space being a space in which the compression mechanism operates; and the actuator being positioned outside of the operating space.

According to another example aspect, the present disclosure provides a monitoring system for monitoring a patient undergoing cardio pulmonary resuscitation (CPR), the system comprising the CPR apparatus described above and a feedback system adapted to monitor and assess hemodynamic indicators in the patient during the CPR performed by the CPR apparatus.

### BRIEF DESCRIPTION OF THE DRAWINGS

Example embodiments of the present disclosure are provided in the following description. Such description makes reference to the annexed drawings wherein:

FIG. 1 is a perspective view of a cardiopulmonary resuscitation (CPR) apparatus in accordance with an example embodiment of the present disclosure;

FIG. 2 shows the CPR apparatus of FIG. 1 with a first arm in a lowered position;

FIG. 3 shows the CPR apparatus of FIG. 1 with the first arm in a raised position;

FIG. 4 shows the CPR apparatus of FIG. 1 with the first arm in a first rotated position;

FIG. 5 shows the CPR apparatus of FIG. 1 with the first arm in a second rotated position;

FIG. 6 shows the CPR apparatus of FIG. 1 in use with a fluoroscopy table;

FIG. 7 is a block diagram of a monitoring system having the CPR apparatus of FIG. 1 in accordance with an example embodiment of the present disclosure; and

FIG. 8 is a perspective view of a CPR apparatus in accordance with another example embodiment of the present disclosure.

### DESCRIPTION OF EXAMPLE EMBODIMENTS

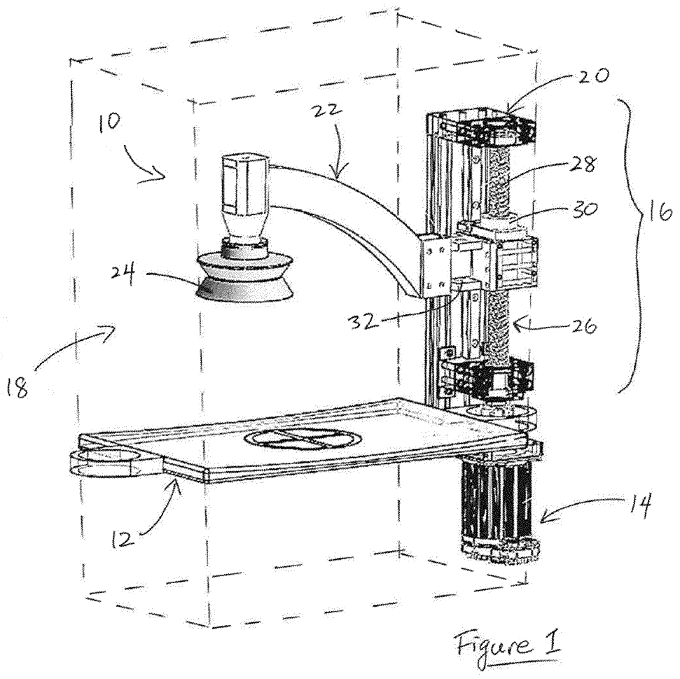

Referring to FIG. 1, a perspective view a cardiopulmonary resuscitation (CPR) apparatus 10 in accordance with an example embodiment is shown. The example implementation of CPR apparatus 10 is for illustrative purposes only, and variations including additional, fewer and/or varied components are possible.

As shown in FIG. 1, the example CPR apparatus 10 generally comprises a backboard 12, an actuator 14, and a compression mechanism 16.

Backboard 12 is shown to be generally planar and rectangular, in this case being adapted for supporting at least a portion of a chest of a patient. It would be understood by the skilled person that backboard 12 may be a different shape and/or a different size. For example, backboard 12 may be ergonomically designed and/or it may be designed to support a different body part of the patient.

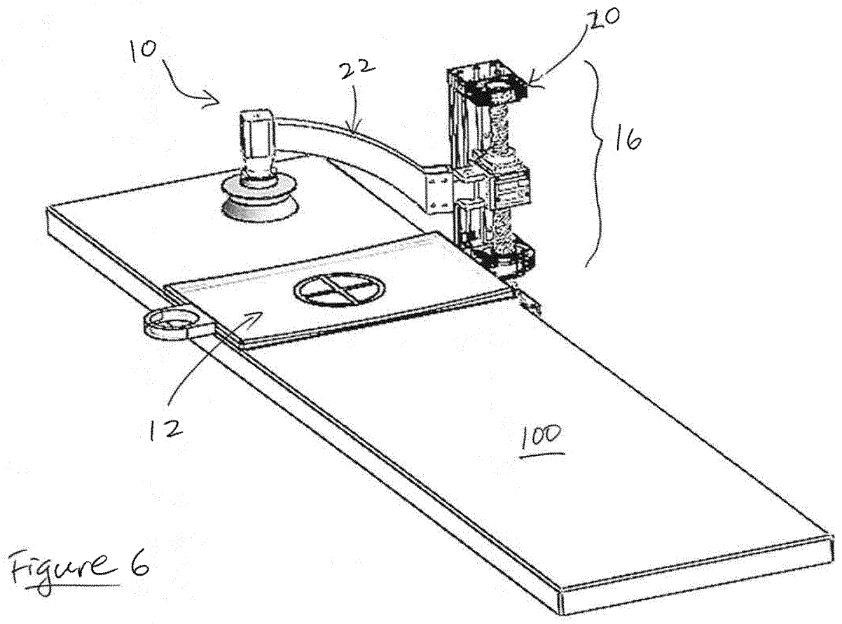

In the depicted embodiment, backboard 12 is dimensioned to be placed on top of a support, such as a fluoroscopy table 100 (see FIG. 6 for example) and is generally planar so that backboard 12 can be slid under a patient 102 from one side (not shown in FIGS. 1-6) who is already lying on the operating table 100. CPR apparatus 10 may be positioned at any location along the length of the table 100. In an alternate embodiment (not shown), backboard 12 may further include rollers to assist in facilitating the sliding of backboard 12 under the patient.

In another alternate embodiment (not shown), the CPR apparatus 10 may not include backboard 12. For example, the CPR apparatus 10 may be mounted directly to the operating table 100 with the patient 102 being supported by the operating table 100. The compression mechanism 16 (or guide rail 20, described further below) may be securable to the support on which patient 102 is lying. For example, a stabilizing mechanism may be used to secure guide rail 20 to fluoroscopy table 100 or to a stretcher. In other examples, the CPR apparatus 10 may include a support, other than backboard 12. Generally, the patient 102 may be supported by any suitable support (which may be part of the CPR apparatus 10, such as backboard 12 or other component; or the support may not be part of the CPR apparatus 10). For simplicity, the following description refers to an embodiment of the CPR apparatus 10 that includes backboard 12 as the support. However, it should be understood that the general operation of the CPR apparatus 10 may be similar in embodiments where there is no backboard 12.

Actuator 14 is operatively coupled to compression mechanism 16 for actuating the compression mechanism 16 to perform the chest compressions. Actuator 14 may be a servo motor, or any other suitable driving mechanism. In the disclosed embodiment, the servo motor used may be quieter than the motors used in conventional CPR devices. The quieter motor may allow the doctors and staff to more easily converse while CPR apparatus 10 is operating.

Compression mechanism 16 includes a guide rail 20 fixed to backboard 12 and a first arm 22. In the depicted embodiment, first arm 22 is radiolucent, curved and slidably coupled at one end to guide rail 20. In this manner, first arm 22 extends or is cantilevered from guide rail 20 over backboard 12.

In this manner, compression mechanism 16 is supported by backboard 12 and is configured to repeatedly perform chest compressions on patient 102 in an operating space 18. Operating space 18 is herein defined as the space in which compression mechanism 16 and other imaging devices (not shown) operate. Operating space 18 may include the space in the vicinity of backboard 12 in which the chest compressions are performed by the compression mechanism.

Operating space 18 may include the space above backboard 12, and may further optionally include the space situated below the area in which compression mechanism 16 and other imaging devices operate, including a lower space below backboard 12. For example, the boundaries of operating space 18 in one embodiment is shown in FIG. 1 with dashed lines.

Notably, actuator 14 is positioned outside of operating space 18. For example, as shown in FIG. 1, actuator 14 in the present embodiment is secured to a bottom end of guide rail 20, below backboard 12 and beside operating space 18, and thus positioned outside of operating space 18. As would be understood by the skilled person, actuator 14 may instead be positioned beside and above backboard 12 or a distance away from operating space 18. In such an embodiment, the location of both actuator 14 and compression mechanism 16 above backboard 12 may facilitate usage of CPR apparatus 10 in situations where the patient 102 is not on an operating table 100, such as situations outside of the cath lab.

Generally, actuator 14 is positioned in a location that is outside of operating space 18, such that the presence of actuator 14 does not interfere with imaging, such as angiographic imaging, that may need to be performed simultaneously with the performance of CPR. In that regard, actuator 14 may be placed in any location such that it does not interfere with the supplemental imaging.

While the shape of operating space 18 is shown in the Figures to correspond with the shape of backboard 12, as understood by the skilled person, operating space 18 may instead have a different shape (including irregular shape) and/or be larger or smaller than backboard 12.

Actuator 14 is operatively coupled to guide rail 20 to drive first arm 22 to move along guide rail 20. In the present invention, the movement of first arm 22, when positioned to extend over backboard 12, towards a patient supported on the backboard 12 compresses the patient's chest. Subsequently, the movement of first art 22 away from the patient allows the chest to expand. First arm 22 includes a compressor pad 24 at the distal end of first arm 22. Compressor pad 24 of first arm 22 comes into contact with the patient to compress the chest. While compressor pad 24 is shown at the distal end of first arm 22 in FIG. 1, compressor pad 24 may be fixed at the distal end or may alternatively be slidable along first arm 22 and repositioned.

In the embodiment depicted, guide rail 20 includes a ball screw 26 having a threaded shaft 28 and a ball nut 30 engaging therewith. First arm 22 is secured to ball nut 30 and actuator 14 is operatively coupled to threaded shaft 28, forming a linear actuating mechanism.

As shown, actuator 14 is coupled to ball screw 26 to provide reciprocating rotational motion at the desired rate, torque, and displacement. In that regard, actuator 14 rotates threaded shaft 28, and this rotating motion is translated into linear translational movement of ball nut 30 relative to threaded shaft 28. Since first arm 22 is fixed to ball nut 30, the linear translational movement is also imparted to first arm 22 relative to backboard 12. This linear translational movement of first arm 22 brings compressor pad 24 into contact with the patient (supported on the backboard 12) to compress the chest. Although a ball screw is shown, a different mechanism may be used instead. For example, a rack and pinion, a lead screw, or a segmented spindle may be used instead of the ball screw. Actuator 14 may be a cam actuator, a rigid belt actuator, a pneumatic actuator, a hydraulic motor, a linear motor, or pulley cable motor. In further alternate embodiments, actuator 14 and ball screw 26 may be replaced with a rotation motor coupled to a pull cable system, or a touched belt and toothed gear system.

With conventional CPR apparatuses, their motors and pistons are typically, enclosed with radiopaque materials, positioned in a cranial or caudal position above the patient, with the most useful views in the −40 degrees to +40 degrees and right or left to the extent, and, therefore, interfere with performing imaging, particularly in the context of a cath lab setting, when the patient is in cardiac arrest. Some of the most useful views that interventionalists rely upon may have no or very little angulation thus causing existing CPR mechanisms to frequently obstruct view of anatomy and devices being utilized. For example, the driving mechanisms (which can include the battery, metal lead screws and the electric motor) block and interfere with x-rays. The physical bulk of the driving mechanisms may also directly interfere with the cardiologist's view and/or access to the patient's coronary arteries.

In examples of the present disclosure, the profile of the CPR apparatus 10 above backboard 12 is reduced to only first arm 22. As well, the only components which extend over or under the patient within operating space 18 include first arm 22 and backboard 12. First arm 22 and backboard 12 may be made of radiolucent materials, such as wood, carbon fiber, or a similar composite, to ensure that angiographic views can be obtained in spite of their presence in operating space 18 during CPR.

The curved shape of first arm 22 may further allow imaging components of an imaging system (e.g., a C-arm of a fluoroscopy imaging system) to be positioned closer to the patient within operating space 18, as compared to existing CPR devices on the market. This may allow for more angiographic views to be taken at different angles (including straight down over the patient), and resulting in clearer angiographic images.

Conventional mechanical CPR devices can typically only produce compressions at a set depth and rate. In the disclosed example CPR apparatus 10, first arm 22 may move linearly up and down a certain distance along the length of guide rail 20 during each compression. The distance traveled by first arm 22 for each compression may be precisely controlled by actuator 14. In this manner, the compression depths used in the CPR may be customized. In this regard, compression depths may be adjustable within, but not limited to, the range of 2-6 cm. This depth can be set by the healthcare team to meet the patient's needs. For example, the desired compression depth may be inputted to actuator 14 (e.g., via a dial or a voice input device coupled to a control system 23 that is operatively coupled to actuator 14) and the actuator 14 may then control movement of first arm 22 in order to achieve the desired compression depth. The control system will be further described below.

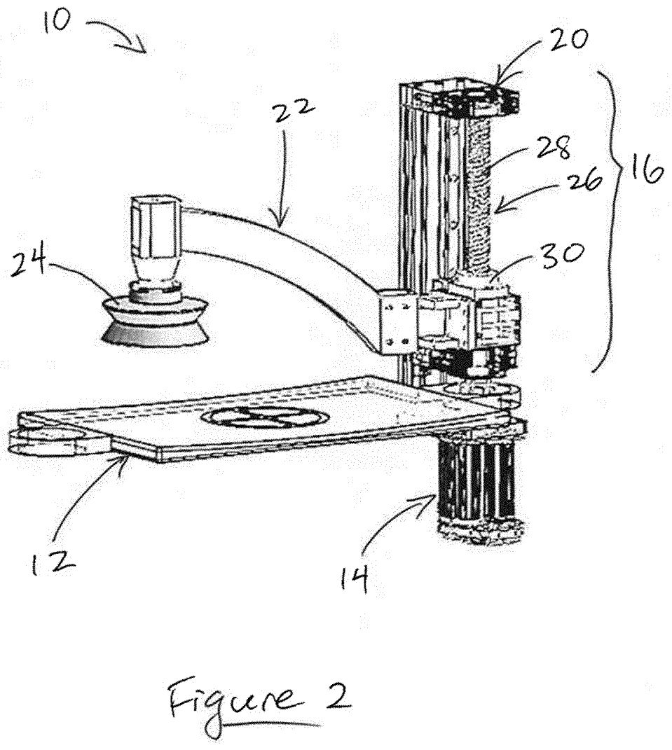

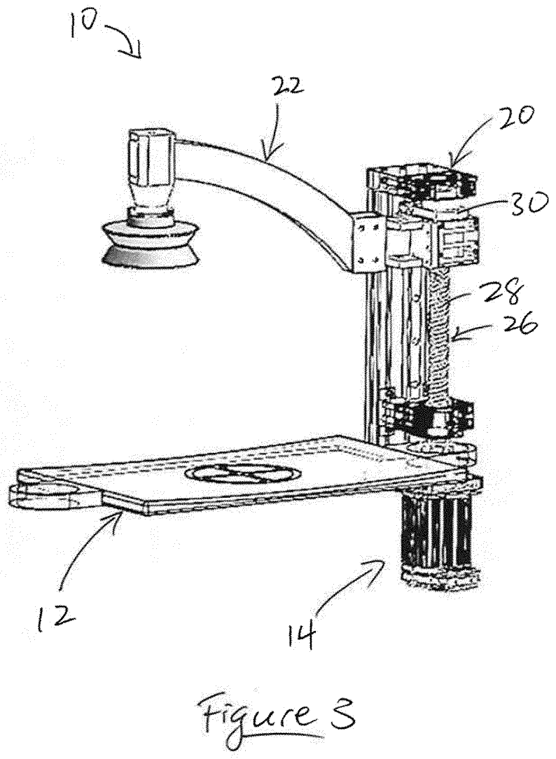

Moreover, the initial height of first arm 22 may also be adjusted along the length of guide rail 20, for example to accommodate the size of the patient. FIG. 2 illustrates an example in which ball nut 28 and first arm 22 have been positioned at a lower portion of guide rail 20, for example for use with a smaller patient. In FIG. 3, ball nut 30 and first arm 22 have been positioned at an upper portion of guide rail 20, for example for use with a larger patient. In some examples, a patient chest height of 15-30 cm may be accommodated by CPR apparatus 10, although other ranges may be possible.

In some examples, compressor pad 24 may further include a fastener (not shown) that is securable to the patient. The fastener may be secured to the patient's sternum, for example, in order to pull the sternum up (or otherwise urge the patient's chest to expand) after each chest compression.

Alternatively, rather than a fastener, compressor pad 24 may include a less invasive suction cup (not shown). Similar to the fastener, the suction cup may help to pull up the patient's chest after each chest compression, to help facilitate full decompression of the heart muscle following each compression. The suction cup may be adapted so that it may be moved laterally (e.g., along the x and/or y-axis) along the surface of the patient's chest. This allows the position of the suction cup to be placed in or adjusted to a specific position over the patient's sternum. This also allows for independent movement of the suction cup relative to the rotational movement of first arm 22 due to hinge 32.

Guide rail 20 may be a telescoping guide rail 21 such that the overall height of guide rail 20 may be adjusted. For example, ball screw 26 may only form a portion of the length of guide rail 20, such as the upper 2-6 cm portion of guide rail 20. The remaining portion of guide rail 20 below ball screw 26 may then form the telescoping portion separate from ball screw 26. In this embodiment, first arm 22 is generally always positioned in the uppermost portion of guide rail 20 with ball screw 26, while the telescoping lower portion of guide rail 20 is adjustable, raising and lowering both ball screw 26 and first arm 22. This, in turn, allows the height of first arm 22 relative to backboard 12 to be further adjusted. The telescoping nature of guide rail 21 may have the added benefit of allowing the amount of hardware present above first arm 22 to be reduced, enabling CPR apparatus 10 to have a smaller profile around which the doctors and staff may have to navigate. The height of telescoping guide rail 21 may be manually adjusted by a user, or the telescoping portion may be operatively coupled to, and controlled by, actuator 14.

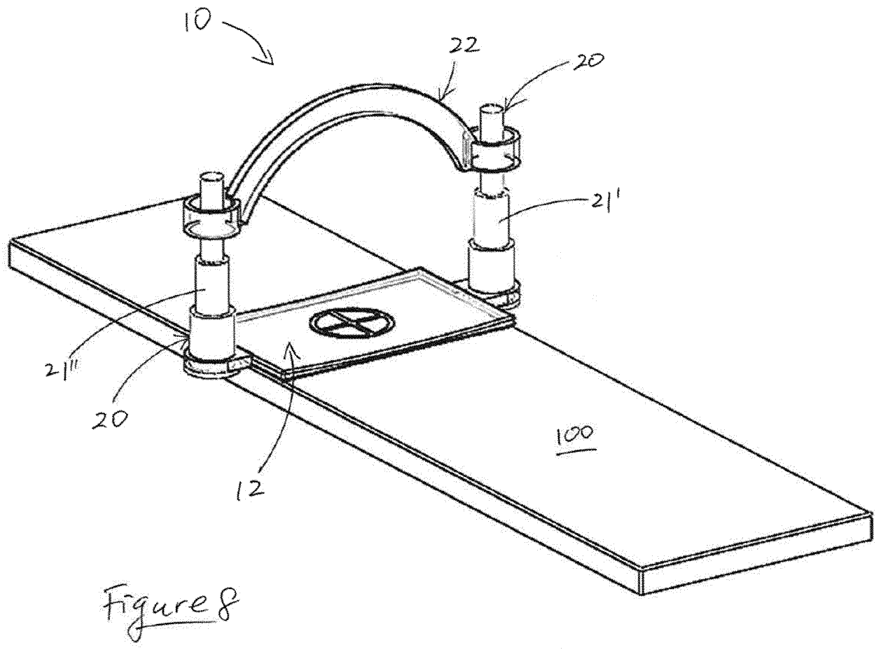

FIG. 8 illustrates an alternate embodiment of CPR apparatus 10 with two, or dual, telescoping guide rails 21′ and 21″. The embodiment in FIG. 8 includes actuator 14 (hidden by operating table 100) below the first telescoping guide rails 21′ and a single first arm 22 spanning the two telescoping guide rails 21′ and 21″. In this embodiment, actuator 14 moves first arm 22 via the first connected guide rail 21′, while the opposite or second telescoping guide rail 21″ is present to provide structural support to first arm 22. Due to their telescoping nature, the overall height of the guide rails 21′, 21″ may be adjusted

In a further alternate embodiment of CPR apparatus 10 with two telescoping guide rails, CPR apparatus 10 may include two actuators 14 (not shown), one operatively coupled to each respective guiderail 21′, 21″ and positioned outside operating space 18. The two actuators may move their respective ball screws 26 and ball nuts 30 in unison to actuate compression mechanism 16 to perform the chest compressions.

While two telescoping guide rails 21′ and 21″ are shown in CPR apparatus 10 of FIG. 8, the telescoping feature of guide rail 20 may alternately be implemented on a single guide rail 21.

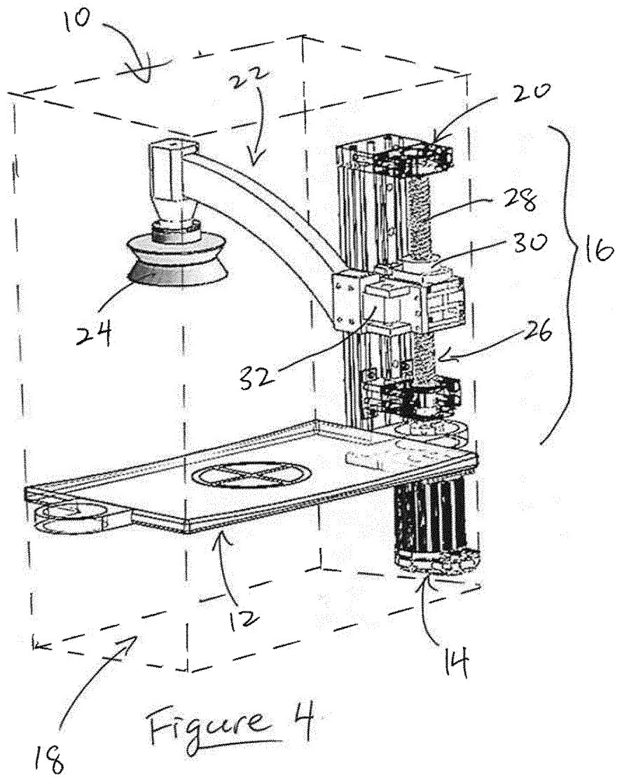

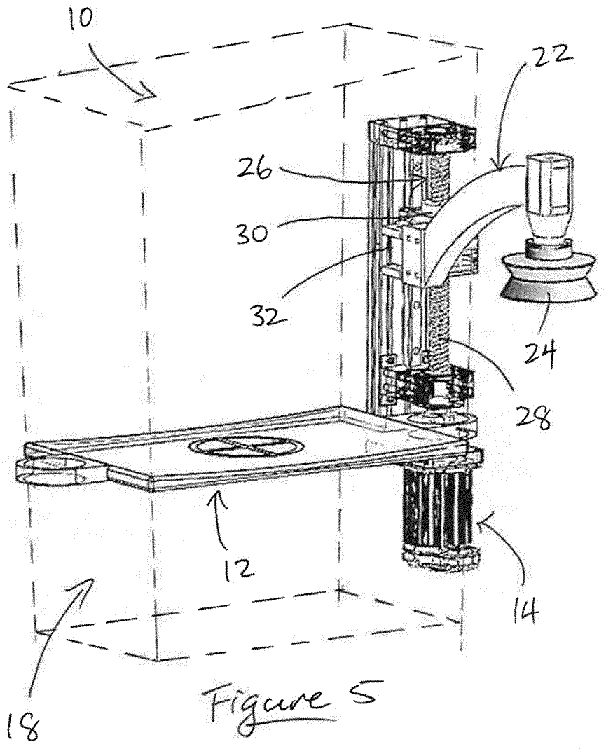

Returning to the embodiment shown in FIGS. 1-6, first arm 22 may also be pivotably coupled to guide rail 20 such that first arm 22 may be pivoted into and out of operating space 18. As shown in FIGS. 4-5, for example, first arm 22 may be coupled to guide rail 20 via a hinge 32. In this manner, first arm 22 may have a pivot angle of 180 degrees relative to guide arm 20 along a horizontal plane, although other range of angles may also be possible. FIGS. 4 and 5 show first arm 22 pivoted out of operating space 18, such that first arm 22 is largely positioned outside of operating space 18. FIG. 1 shows first arm 22 pivoted into operating space 18. As also shown in the present embodiment, first arm 22 has a curvature that allows first arm 22 to extend over and around the patient and to clear the patient should first arm 22 be pivoted into or out of operating space 18.

Hinge 32 may further include a locking device (not shown) to lock or maintain hinge 32 in place. In this manner, the locking device may be used to maintain first arm 22 outside of operating space 18 when manual compressions are being performed on the patient. The locking device may also be used to maintain first arm 22 in the desired position over the patient inside operating space 18 when mechanical compressions are being performed.

When first arm 22 is pivoted out of operating space 18, this allows manual chest compressions to continue to be performed on a patient until CPR apparatus 10 is positioned about the patient and ready to be turned on. This pivoting feature, along with the planar nature of backboard 12, allows for a relatively quick setup and relatively minimal movement of the patient during the setup of CPR apparatus 10. Moreover, these features may also allow manual CPR to be performed without pause during the setup of CPR apparatus 10 before mechanical CPR commences. Once CPR apparatus 10 is in place, first arm 22 may be pivoted into place over the patient's sternum and mechanical CPR may commence.

Actuator 14 and guide rail 20 may be enclosed in a housing, such as an accordion sleeve (not shown), which may help to ensure safety of the operator, protection of the mechanical parts therein and/or to reduce wear. Alternately or additionally, ball screw 26 and ball nut 30 may be enclosed in a ball nut housing (not shown). The ball nut housing may surround 26 and ball nut 30 so as to keep the internal mechanisms relatively clean, and to prevent accidental contact, and possible injury, to the users.

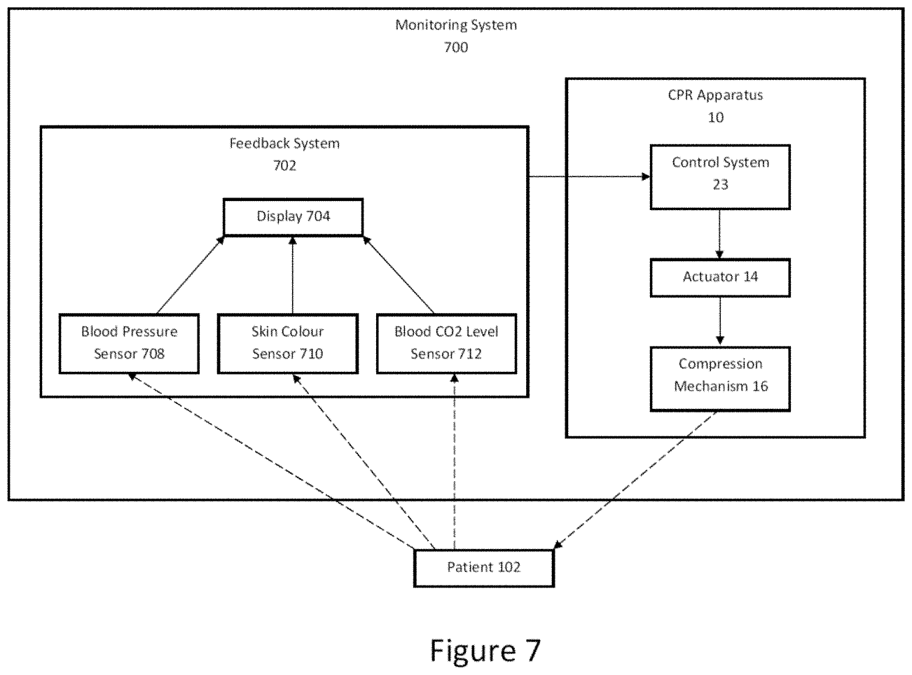

Actuator 14 may further have a control system 23 (see FIG. 7 for example), either directly or remotely coupled to actuator 14 as mentioned above. Control system 23 may have an input mechanism (e.g., button, dial, switch, touchscreen or keyboard) for controlling operation of CPR apparatus 10. For example, user input to control system 23 may be used to control parameters such as compression depth and/or compression speed applied to the patient by compression mechanism 16. Along with the compression depth discussed above, the compression rate can also be adjusted (e.g., selected within a range of 100 to 120 compressions per minute, or other possible range), which may help to adhere to current American Heart Association guidelines.

In another example, actuator 14 may be coupled to control system 23 to provide feedback, such as torque measurements and/or the amount of force or displacement applied. Control system 23 may then use this feedback to control and adjust the torque and/or the amount of force or displacement applied by actuator 14 over time.

The input mechanism of control system 23 may include a “Pause” button that, when triggered, temporarily stops actuator 14. For example, actuator 14 may be stopped for a period of ten seconds (or other time period) for example during sensitive critical moments of a cath lab procedure in which any movement in operating space 18 may interfere with the work of the interventional cardiologist.

Control system 23 may be operatively coupled to a pressure sensor (not shown) incorporated into backboard 12. The pressure sensor may be adapted to detect pressure applied to the pressure sensor in backboard 12, for example pressure applied by first arm 22 to the patient lying on backboard 12. The pressure sensor may be adapted to send pressure signals to control system 23. Control system 23 may be configured to use the pressure signals as feedback, to adjust the pressure applied by actuator 14 through compression mechanism 16. This may help to ensure that a sufficient amount of pressure is being applied for effective CPR, and may also help to ensure that excessive (and potentially harmful) amount of pressure is not applied to the patient. User input may be used to set maximum and minimum permissible values for the applied pressure. Additionally or alternatively, an absolute maximum operating pressure may be preset in control system 23, and control system 23 may automatically control the actuator 14 to avoid reaching or exceeding the absolute maximum operating pressure.

Other sensors (not shown) may be incorporated into backboard 12 (or elsewhere in CPR apparatus 10). For example, a motion sensor (e.g., accelerometer) may be incorporated into backboard 12 to detect whether backboard 12 is moving. Movement of backboard 12 may indicate that the patient is moving and that CPR make be less effective than expected.

As a safety feature, a proximity sensor (not shown) may be provided on or near first arm 22 for detecting contact of first arm 22 with an obstacle, such as another piece of equipment or staff member in the operating room. The proximity sensor may be operatively coupled to actuator 14. When contact with first arm 22 is sensed by the proximity sensor, the proximity sensor may be adapted to send a signal to actuator 14 to stop movement of first arm 22 and/or to turn actuator 14 off. Alternatively, or additionally, a further safety feature on first arm 22 may include bellows or a safety bar (not shown). The safety bar may detect contact of first arm 22 with any obstacle. Should any other part of first arm 22, other than compression pad 24, contact the patient or any other obstacle, the safety bar may trigger the actuator 14 to stop movement of first arm 22 and/or to actuator 14 turn off. This helps to maintain a safe distance between curved first arm 22 and the patient's chest during mechanical CPR, and helps to ensure that the only point of force is at the sternum.

While not shown in the Figures, CPR apparatus 10 may include a second arm, possibly radiolucent, which is adapted to perform a second function, while first arm 22 is performing the chest compressions. For example, the second function may be to encourage blood circulation in the patient. In this case, the second arm may include a thoracic compressions device for circulating blood in the patient.

In another example, the second function may be to force excess air from the patient's abdomen during CPR after air has been forced into the patient's lungs. In this case, the second arm may be positionable over the patient's abdomen and configured to perform abdomen compressions on the body while first arm 22 is performing the chest compressions. This second function may be part of a concurrent extracorporeal perfusion (ECP) process, which may involve diversion of the patient blood's through an artificial circuit and providing gas exchange for oxygen and carbon dioxide.

In some embodiments, the second arm may be operatively coupled to actuator 14, which also drives the secondary device, or the second arm may be operatively coupled to a second actuator.

In the case where both first arm 22 and the second arm are operatively coupled to actuator 14, actuator 14 may be connected to a second ball screw to which the second arm is operatively coupled. If the second function is to force excess air from the patient's abdomen during CPR, actuator 14 may move the second arm at a different rate than first arm, for example, in order to deliver standard chest compression to breathing ratios of about 30 to 2 in adults. Actuator 14 may also drive the first and second ball screws to deliver a different chest compression to breathing ratio. Additionally or alternatively, the second ball screw may be driven by actuator 14 in an opposite direction than that of first ball screw 26, and/or the abdomen compressions may have a different depth than those of the chest compressions.

In the case where there is a second actuator operatively coupled to the second arm, the second actuator may also be connected to a second ball screw to which the second arm is operatively coupled. The second actuator may also be positioned outside of operation space 18, and may drive the second ball screw similarly to the operation of actuator 14 as described above.

CPR apparatus 10 may further include a stabilizing mechanism that stabilizes or fastens CPR apparatus 10 to a table/stretcher. Such a stabilizing mechanism may enable the device to stay fixed in position on the patient during operation of CPR apparatus 10.

### Monitoring System

Further to the above, in some examples, CPR apparatus 10 may be used as part of a larger monitoring system 700, see FIG. 7, to monitor the patient 102 undergoing CPR. The monitoring system 700 may include components conventionally found in an operating room, for monitoring a patient 102 during a medical procedure. In addition to CPR apparatus 10, monitoring system 700 may include a feedback system 702 adapted to monitor and assess hemodynamic indicators in patient 102 during the CPR performed by the CPR apparatus 10. Feedback system 702 may provide output (e.g., via an output device, such as a monitor or display 704) showing the hemodynamic indicators.

The hemodynamic indicators of patient 102 monitored by feedback system 702 include: blood pressure, skin colour, and carbon dioxide levels in the blood, among others. These parameters may be monitored by a blood pressure sensor 708, a skin colour sensor 710, and a blood CO2 level sensor 712, among others, which form part of feedback system 702. Feedback system 702 may be coupled to control system 23 of CPR apparatus 10, and configured to signal actuator 14 in CPR apparatus 10 to adjust the chest compressions performed by compression mechanism 16 on patient 102 depending on the assessment by feedback system 702 of the hemodynamic indicators of patient 102. Although FIG. 7 shows feedback system 702 as a larger block encompassing display 704, blood pressure sensor 708, skin colour sensor 710 and blood CO2 level sensor 712, it should be understood that components of feedback system 702 may be implemented as separate and independent systems.

Based on the hemodynamic indicators shown in display 704, the cardiologist or staff member may manually adjust the chest compression depth and/or rate applied by compression mechanism 16 through actuator 14 using the input mechanism, such as the dial, on control system 23. Additionally or alternatively, CPR apparatus 10 may be adapted to automatically adjust the chest compression depth and/or rate in response to the signals from feedback system 702.

Monitoring system 700 may also be configured to receive feedback or data from the safety bar and the pressure sensor in backboard 12 as discussed above. In another embodiment, monitoring system 700 may adjust the chest compression depth and/or rate in response to images or data from other systems, such as ECG equipment. Monitoring system 700 may also adjust the chest compression depth and/or rate in response in response to manual feedback from the operator or user.

While the teachings described herein are in conjunction with various embodiments for illustrative purposes, it is not intended that the teachings be limited to such embodiments. On the contrary, the teachings described and illustrated herein encompass various alternatives, modifications, and equivalents, without departing from the described embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

1. A cardio pulmonary resuscitation (CPR) apparatus for performing a chest compression on a patient supported by a support, the CPR apparatus comprising:
an actuator operatively coupled to a compression mechanism for actuating the compression mechanism to perform the chest compression;
the compression mechanism being securable to the support and configured to repeatedly perform chest compressions on the patient in an operating space, the operating space being a space in which the compression mechanism operates; and
the actuator being positioned outside of the operating space.

2. The CPR apparatus of claim 1, wherein the operating space further includes a lower space situated below the space where the chest compressions are performed by the compression mechanism.

3. The CPR apparatus of claim 1, wherein the compression mechanism comprises:
a guide rail securable to the support;
a first arm slidably coupled to and extending from the guide rail over the support;
the actuator being coupled to the guide rail to drive the first arm to move along the guide rail:
toward the support to effect the chest compression; and
away from the support.

4. The CPR apparatus of claim 3, wherein the first arm is radiolucent.

5. The CPR apparatus of claim 4, wherein the first arm includes a compressor pad at a distal end of the first arm, the compressor pad being adapted for contacting the chest and having a fastener securable to the patient's sternum for pulling the sternum up after each chest compression.

6. The CPR apparatus of claim 3, wherein the guide rail includes a ball screw having a threaded shaft and a ball nut, the first arm being secured to the ball nut and the actuator being operatively coupled to the threaded shaft such that rotation of the threaded shaft by the actuator is translated into linear translational movement of the ball nut and first arm relative to the threaded shaft.

7. The CPR apparatus of claim 3, wherein the guide rail is a telescoping guide rail.

8. The CPR apparatus of claim 3, wherein the first arm is pivotably coupled to the guide arm, such that the first arm may be pivoted out of the operating space.

9. The CPR apparatus of claim 3, wherein the actuator is secured to an end of the guide rail.

10. The CPR apparatus of claim 3, wherein the first arm includes a proximity sensor for detecting contact of the first arm with an obstacle, the proximity sensor being configured to send signals to the actuator to stop movement of the first arm upon sensing contact of the first arm with the obstacle.

11. The CPR apparatus of claim 3, further comprising a second arm operatively coupled to the actuator or to a second actuator, the second arm being configured to perform a second function.

12. The CPR apparatus of claim 11, wherein the second function is to encourage blood circulation in the patient and the second arm comprises a device for circulating blood in the patient.

13. The CPR apparatus of claim 11, wherein the second function is to force excess air from the patient's abdomen during CPR, the second arm being positionable over the patient's abdomen and configured to perform abdomen compressions on the body.

14. The CPR apparatus of claim 1, wherein the support is a backboard for supporting at least a portion of a chest of the patient, wherein the compression mechanism is supported by the backboard.

15. The CPR apparatus of claim 14, further comprising a control system operatively coupled to the actuator, the control system being configured for controlling compression depth and/or compression speed applied by the compression mechanism.

16. The CPR apparatus of claim 15, wherein the backboard comprises a pressure sensor for detecting pressure, the pressure sensor being configured to send pressure signals to the control system, the control system being configured to, in response to the pressure signals, control the actuator to adjust pressure applied by the compression mechanism.

17. A monitoring system for monitoring a patient undergoing cardio pulmonary resuscitation (CPR), the system comprising:
the CPR apparatus of claim 1; and
a feedback system adapted to monitor and assess hemodynamic indicators in the patient during the CPR performed by the CPR apparatus.

18. The monitoring system of claim 17, wherein the hemodynamic indicators of the patient monitored by the feedback system include: blood pressure, skin colour, or carbon dioxide levels in the blood.

19. The monitoring system of claim 17, wherein the feedback system is coupled to the CPR apparatus, and is configured to signal the CPR apparatus to adjust the chest compressions depending on the hemodynamic indicators of the patient.

20. The monitoring system of claim 17, wherein the CPR apparatus is adapted to automatically adjust the chest compressions in response to the signals from the feedback system.
